(19) United States
(12) Patent Application Publication
(10) Pub. No.: US 2010/0187817 A1
(43) Pub. Date: Jul. 29, 2010

(54) SLIDE CORNER CONNECTOR FOR FLANGE

(76) Inventor: Stephen S. Martin, Huntington Station, NY (US)

Correspondence Address: Barry G Magidoff, Esq., Paul J. Sutton, Esq.;Sutton Magidoff LLP, 909 Third Avenue - 27 FL, New York, NY, 10022, US

(21) Appl. No.: 12/694,979

(22) Filed: Jan. 27, 2010

Related U.S. Application Data
(60) Provisional application No. 61/148,158, filed on Jan. 29, 2009.

(51) Int. Cl. F16L 23/00

(52) U.S. Cl. 285/412

(57) ABSTRACT

An angular, slidable corner connector for securing the corners and joining of a pair of flange frames for ductwork. The frames are formed of transversely aligned edge members and the corner connectors serve to reinforce and connect sheet metal ducts. Each frame edge has longitudinally directed channels. The corner connector is capable of being formed on site. The corner connector comprises two separate legs that are held together. A first leg has a transversely extending slot formed at one end thereof, the leg and the slot being formed from a single piece of material. The second leg has an end slot stop. The corner connector is formed by sliding the second leg through the transversely extending slot in the first leg until the end slot stop abuts against the second leg, the overlapping portions of the first and second legs form the apex of the corner connector.

This application claims the benefit of priority pursuant to 35 U.S.C. 119(e) from a U.S. provisional patent application having Application No. 61/148,158 filed Jan. 29, 2009.

### BACKGROUND OF THE INVENTION

The present invention is directed to an improved angular slidable corner connector for assembling the frames for forming the flanges used for reinforcing and connecting sheet metal ductwork. The ductwork, the frame sides and the corner connectors are commonly formed of sheet metal, most commonly galvanized steel, but they may also be formed of aluminum sheet. Ductwork usually have rectangular (including square) or circular or ovoidal cross-sections. The rectangular frames forming the connecting flanges are generally assembled from four straight members, interconnected by, e.g., right angle corner connectors.

Such right angle connectors are each generally formed as a single massive piece from the same sheet metal as the frame members and the duct walls, often with a corner reinforcement of the same material. It is well known to form a rectangular frame comprised of four linear frame components, the terminal edges of the frame components being linked by the right angle connectors.

One problem with the connectors of the prior art is their lack of suitability where the frame components to be connected are not substantially square in cross-section, i.e., having different width and length. It is often desirable that each of the corner connectors extend substantially one-half of the length of each straight member forming the frame. This helps avoid undesirable twisting of the frame members under applied stresses. When the sides of the ducts are of different lengths, i.e., a rectangle rather than a square, this will require a great many different sizes of corner connectors in order to meet the needs of the different size ducts.

### BRIEF SUMMARY OF THE INVENTION

It is accordingly an object of the present invention to provide a corner connector which is assembled in situ when connecting the flange frame members. It is a further object to permit forming the corner connector with different length leg portions. It is yet a further object to permit forming the connector with an inherent corner reinforcement.

In accordance with the present invention there is provided an angular slide corner connector for connecting adjacent flange frame members to form a generally rectangular frame having terminal ends being linked by four of the corner connectors. The two angled legs of the corner connector can be connected together at the time of constructing the corner connector, so that the selection of each leg can be determined by the length of the frame member into which it is to be inserted. Specifically, two equal sized legs can be connected for a substantially square duct, whereas two different length legs are connected where the sides of the duct are of substantially different lengths.

The two legs are formed to have mating members, such as a slot on one leg, formed at the corner end portion of one leg, and a locking end on the second leg, intended to mate with the slot end so as to prevent the passage of the second leg completely through the slot. The slot can be formed in many well-known ways, including folding an extended portion of the first leg over the end and leaving sufficient space to pass the second leg between the folded over portion and the leg, with a locking end on the second leg to stop the second leg from passing completely through the slot. Alternatively, an open slot can be formed by forming multiple folds where the second legs passes between the two folds and is held in place. In either case, to form a rectangular frame, the corner connector legs must be at right angles to each other. In any manner of forming the slot in one of the legs, such a configuration allows a sliding leg member with an inwardly bent corner end portion to slide into the receiving corner slot portion of the connector and securely fasten itself, forming an angular connector having a pair of legs extending at a right angle to each other.

In either case, an opening is formed wholly through each leg material, at the apex location of the corner when the legs are joined, to permit a fastener to pass wholly through so as to allow for connection to another frame.

### BRIEF DESCRIPTION OF DRAWINGS

Referring to the drawings, they present examples of a presently preferred embodiment of the present invention, but such embodiments are not to be taken as being exclusive and as defining the full scope of this invention.

Exemplary, and preferred, embodiments of the invention are shown in the following drawings:

FIG. 1 is a perspective view of one leg of a corner connector, including a corner connecting portion having an end portion bent inwardly towards the far end of the leg (which in this case is tapered towards the end of the leg), and a triple bent portion which forms the slot at the corner end of this first leg;

FIG. 2 is a perspective view of the second leg member of the corner connector, including the locking end portion formed by being bent inwardly towards the second end of the leg, forming the lock for holding this leg in the slot formed in the first leg;

FIG. 3 is a perspective view of this preferred embodiment of a constructed angular slide corner connector in accordance with the present invention; and

FIG. 4 is a perspective view of a conventional duct and connecting flanges, where the flange frames are formed using the corner connectors of the present invention.

### DETAILED DESCRIPTION OF DRAWINGS

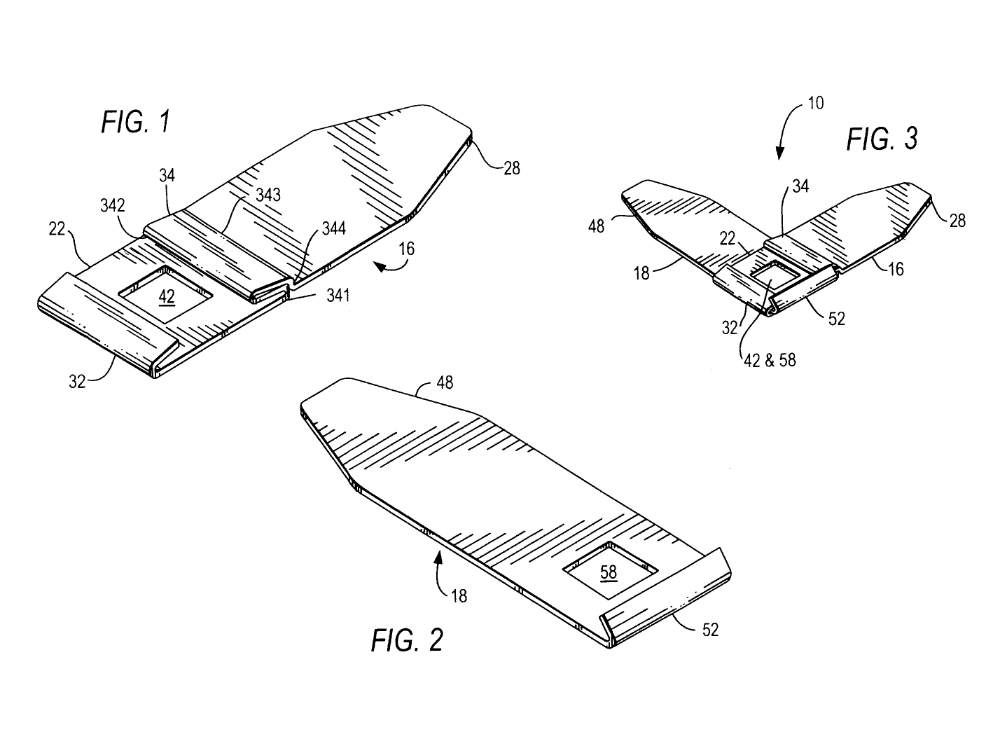

Referring to the drawings, the two legs 16,18, used to form the corner connector 10, are shown in FIGS. 1 and 2; each have a tapered end 28,48 and a bent end 32,52. The bent end 32 in the first leg of FIG. 1 is bent over sufficiently to form a snug fit with the material of the second leg 16, in FIG. 2. The inner bent portion 34 of the first leg 16, is formed as a multiple bend: a first bend 341, bent substantially to the same 180 degrees as the first bend 32 to permit a snug fit of the second leg sliding through; a second multiple return bend 342 which is bent back to extend towards the second end 28 of the first leg, which can be parallel to the general direction of the leg; and a third bend 343 substantially a right angle; and a fourth bend 344 which is also substantially at a right angle so that the leg is substantially in line with the portion of the leg at the first end of the leg, i.e., on the other side of the multiple bend 34. The bent end 52 of the second leg is bent more than 90 degrees, in order to lock onto the bent portions of the first leg.

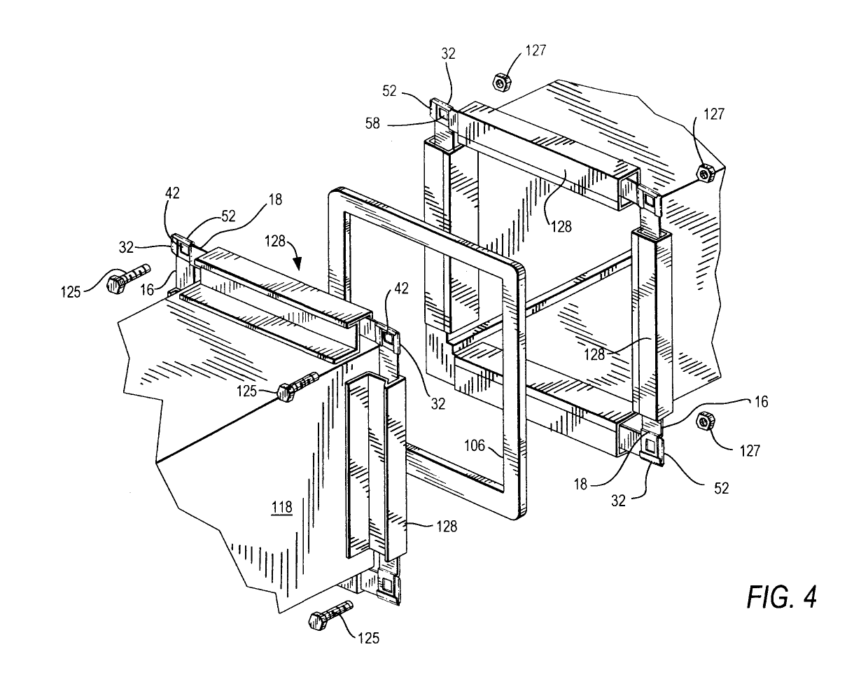

When the two legs 16 and 18 are connected, as shown in FIG. 3, the legs extend transversely, usually at right angles to each other, and are designed to extend into slots in the members forming the completed frame, as is exemplified by FIG. 4, where the members forming the sides of the frames are all linear. The angle between the legs depends upon the number of sides of the ductwork, e.g., a rectangular duct requires a 90 degrees angle. The openings 42,58 through the corner portions of each leg are superimposed one over the other to permit joining together two frames as shown in FIG. 4. The tapered ends of the legs 28 ease the insertion of the second leg through the slot of the first leg and of both legs into their respective frame members.

As illustrated by the arrangement of the drawings of FIGS. 1, 2 & 3, both legs have tapered ends 28, which serve to guide the legs into the slots formed by the bent portions. The corner connector 10 is formed by sliding the tapered end 48 of leg 18 into the bracket portion 22 of the first leg 16 to form the corner connector 10, such that apertures 42 and 58 are aligned and the folded end portion 52 abuts over the end fold portion 32 and double curved central portion 34, as shown in FIG. 3. As shown, the two slot portions are designed so as to overlap the two sides of the second leg so as to prevent movement of the second leg away from the plane of the first leg, as shown in FIG. 3. The corner connector may be assembled prior to inserting either leg into the channels 128 on the flange sides.

The above is exemplary of a highly cost efficient construction that is presently preferred. However, the slot in the first leg can be formed in many different ways known to the art. The above examples are merely exemplary of the present invention and the claims follow set forth the full scope of the claimed invention.

What is claimed is:

1. An angular slide corner connector for joining a pair of flange frames for ductwork, the frames having transversely aligned edges each having longitudinally directed channels, said connector capable of being formed in situ and comprising
a first leg having a transversely extending slot formed at one end thereof, the leg and the slot being formed from a single piece of material,
a second leg having an end slot stop,
the corner connector being formed by sliding the second leg through the transversely extending slot in the first leg until the end slot stop abuts against the second leg, the overlapping portions of the first and second legs forming the apex of the corner connector;
each leg being sized and shaped to extend into the longitudinal channels of the frame edges to connect the frame edges transversely to each other.

2. A connector in accordance with claim 1 having a bolt aperture formed in each leg and arranged to be superimposed, one over the other to form an opening fully through the apex of the corner connector, when the two legs are locked together so as to be capable of receiving a connecting bolt.

3. A connector in accordance with claim 1 wherein said leg portions include a tapered end portion to facilitate initial insertion within the longitudinal channels and the slot.

4. A connector in accordance with claim 1 wherein the slot in the first leg is formed by folding over the first end of the first leg substantially 180° and forming a slot portion, and by a multiple bend located longitudinally distal from the first end to form a second slot portion, wherein the two slot portions are designed so as to overlap the two sides of the second leg so as to prevent movement away from the plane of the first leg.

5. A method for forming a frame for forming a flange for joining ductwork using the corner connector of claim 1 to join the members forming the frame.

6. A method for forming a frame for forming a flange of for joining ductwork using the corner connector of claim 1, wherein the first leg is inserted into one of the two frames to be joined, and the second leg is then inserted through the end slot in the first leg and then into the second frame, to connect the two frame members.

7. A method for forming a frame for forming a flange of for joining ductwork using the corner connector of claim 1, wherein the frame members are each linear.
